(19) United States
(12) Patent Application Publication
(10) Pub. No.: US 2025/0014780 A1
(43) Pub. Date: Jan. 9, 2025

(54) A HIGH-VOLTAGE CABLE AND A METHOD OF MANUFACTURE OF THE CABLE

(71) Applicant: HYDRO EXTRUDED SOLUTIONS AS, Oslo (NO)

(72) Inventor: Torben THOMSEN, Krusaa (DK)

(73) Assignee: HYDRO EXTRUDED SOLUTIONS AS, Oslo (NO)

(21) Appl. No.: 18/712,332

(22) PCT Filed: Dec. 19, 2022
(86) PCT No.: PCT/EP2022/086698

§ 371 Date: May 22, 2024

(30) Foreign Application Priority Data
Dec. 17, 2021 (SE) 2151549-9

(51) Int. Cl. H01B 7/42; B60L 53/18; H01B 7/00; H01B 7/02; H01B 7/20; H01B 13/14; H01B 13/24

(52) U.S. Cl. CPC H01B 7/423; B60L 53/18; H01B 7/0009; H01B 7/0216; H01B 7/201; H01B 13/14; H01B 13/245

(57) ABSTRACT

A high-voltage cable (1) comprising a hollow conductor (2), characterized in that an inner tube (3) is arranged inside the hollow conductor (2), and a first electrically insulating layer (4) is arranged between the innertube (3) and the hollow conductor (2), wherein said first electrically insulating layer (4) is in direct contact with the entire outer surface of the inner tube (3) and the entire inner surface of the hollow conductor tube (2), and a method (100) of manufacture of the cable.

### TECHNICAL FIELD

The present disclosure relates to a high-voltage cable, especially for use in electrical vehicles or hybrid electrical vehicles, and a method of manufacture of the cable.

### BACKGROUND ART

High-voltage (HV) cables are for electric power transmission at high voltage and are used in various applications, such as ignition systems and alternating current (AC) or direct current (DC) power transmission, in particular in the field of hybrid electric vehicle or electric vehicle technology, where voltage power from the battery is amplified to 600 V or higher by an inverter and output to the drive motor via a large-diameter, high-voltage power cable with sufficient current capacity.

The demands on and development within hybrid electric vehicle (HEV)/electric vehicle (EV) technology has led to an increase in the size of high-voltage cables used as power cables due to the higher voltage in the power transmission. However, there is also a continuous strive to reduce the size of the engine room and to decrease the weight of all components in the vehicle.

Thus, there is a need for a high-voltage cable that provides sufficient current capacity, while at the same time is more light-weight and slender.

### SUMMARY

The present disclosure relates to a high-voltage cable, comprising a hollow conductor, characterized in that an inner metal tube is arranged inside the hollow conductor, and a first electrically insulating layer is arranged between the inner metal tube and the hollow conductor, wherein the first electrically insulating layer is in direct contact with the entire outer surface of the inner tube and the entire inner surface of the hollow conductor tube. By the provision of the inner metal tube the first electrically insulating layer can be conveniently held in place on the inside of the hollow conductor, and due to the inward electrical insulation in the hollow conductor the cable can be cooled by means of cooling fluid flowing through the interior of the inner tube. Interior cooling of a high-voltage cable allows for smaller cable cross sectional area as compared to solid non-cooled high-voltage cables used for the same voltage application.

The inner tube is made of metal. The first electrically insulating layer is preferably made of a material having a dielectric strength of 30 kV/mm or higher. More preferably, the material of the first electrically insulating layer is a non-conductive polymeric material, such as a polyamide or a polyethylene, preferably a polyamide.

The cable suitably comprises a second electrically insulating layer arranged on the outside surface of the hollow conductor. A shield layer is suitably arranged outside the second electrically insulating layer. The shield layer is preferably an extruded tube.

The inner tube, the hollow conductor and/or the shield layer may advantageously be made of aluminium or an aluminium alloy, due to the low weight and relatively low cost of aluminium and aluminium alloys.

The cross-sectional area of the cable may be from 70 to 200 mm², or 70-120 mm², and the inner tube may have a diameter of 6-12 mm, such as 6-10 mm or 8-12 mm.

The cable is suitable for installation in electrical vehicles or hybrid electrical vehicles, electrical vessels, or hybrid electrical vessels. The cable is also suitable for installation in charging station infrastructure.

The present disclosure further relates to a method of manufacture of the cable described above. The method comprises the steps of
Providing a first extruded metal tube;
Applying a coating layer of an electrically insulating material onto an outer surface of the extruded metal tube, to obtain a coated inner tube having a first electrically insulating layer;
Providing a second extruded tube of electrically conducting material to obtain a hollow conductor.
Inserting the coated inner tube into the hollow conductor and expanding it until the first electrically insulating layer is in contact with the inner surface of the hollow conductor.

The first electrically insulating layer is suitably applied to the first extruded tube by co-extrusion or powder coating. The expansion of the coated inner tube is a cold forming method, preferably performed by drawing a plug through the inner tube, or by hydroforming.

The method may suitably comprise a step of applying a coating layer of an electrically insulating material onto an outer surface of the hollow conductor, so as to obtain a coated hollow conductor having a second electrically insulating layer, wherein the second electrically insulating layer is preferably applied by co-extrusion. Further, the method may comprise the steps of providing a shield layer in the form of a third extruded tube; and optionally applying a coating layer onto an outer surface of the third extruded tube, to obtain a third coated tube; inserting the coated hollow conductor into the third extruded metal tube; and forming the coated hollow conductor and the shield layer into an assembly by reducing the cross-section diameter of the third extruded metal tube.

The forming the coated hollow conductor and the shield into an assembly by reducing the cross-section diameter of the third extruded metal tube is preferably performed prior to inserting the coated inner tube into the hollow conductor.

The cross-section diameter of the third extruded metal tube may be reduced by swaging, hammering, pressure, roll forming or drawing. Preferably the forming of the coated hollow conductor and the shield layer into an assembly is performed by swaging.

The method may further comprise bending 105 the cable into a desired shape by means of a bending tool.

In the present context, the feature “cross-sectional area of the cable” refers to the cross-sectional area of the conductor in the cable.

### DETAILED DESCRIPTION

The present disclosure aims at providing a high-voltage cable, which is light-weight and narrow for a given current capacity. The described cable is especially suitable for applications where the voltage is from 600-2500 V, e.g. the voltage may be from 600-1200 V. It should be understood that higher voltages are also possible. The cable is suitable for installation in electrical vehicles or hybrid electrical vehicles, to be connected to a charging cable in a charging unit or charging station. The cable is also suitable for installation in electrical vessels or hybrid electrical vessels, such as ships or boats. Other suitable applications are installation in charging station infrastructures and other installations in which a cooled HV cable is beneficial.

Accordingly, the present disclosure relates to a high-voltage cable, comprising a hollow conductor, characterized in that an inner metal tube is arranged inside the hollow conductor, and a first electrically insulating layer is arranged between the inner tube and the hollow conductor, wherein the first electrically insulating layer is in direct contact with the entire outer surface of the inner metal tube and the entire inner surface of the hollow conductor tube. By the provision of the inner metal tube the first electrically insulating layer can be conveniently held in place on the inside of the hollow conductor, and due to the inward electrical insulation in the hollow conductor the cable can be cooled by means of cooling liquid flowing through the interior space of the inner metal tube. Interior cooling of a high-voltage cable allows for smaller cable cross-sectional area as compared to solid non-cooled high-voltage cables used for the same voltage application. By the feature “cable cross-sectional area” it should be understood that this cross-sectional area refers to the conductor cross-sectional area. This is particularly advantageous in the field of electrical vehicles or hybrid electrical vehicles, where the space for cable components is limited and weight needs to be kept low to avoid increase in power consumption. Other applications where the cable may be of use could be e.g. in electrical vessels, or hybrid electrical vessels, charging station infrastructure and software centers or data centers.

Cooling fluids can for example be water or a water/glycol mixture, or a gas, e.g. CO₂.

The first electrically insulating layer is made of a non-conductive material that is suitably capable of withstanding bending and suitably has a sufficient dielectric strength, preventing current in the conductor from reaching the inner tube. The material of the first electrically insulating layer preferably has a dielectric strength of 30-70 kV/mm, more preferably at least 40 kV/mm. Thereby, the first electrically insulating layer can be made relatively thin so as to allow efficient cooling of the conductor, while at the same time sufficient electrical insulation.

More preferably, the material of the first electrically insulating layer is a polymeric material, for example a polyethylene or a polyamide, such as PA12 or the like, which has sufficient dielectric strength and therefore can be made thin enough to provide efficient cooling of the conductor.

It is important that no cooling fluid can reach the conductor, as this might lead to short circuit and damage to equipment and people. Therefore, the first electrically insulating layer should preferably cover and be in contact with the entire surface of the outside of the inner tube without any gaps, and preferably also be in contact with the conductor over its entire inner surface. Advantageously, the first electrically insulating layer is first applied to the inner tube, which is then inserted into the conductor and thereafter expanded, as explained in more detail below. The material of the electrically insulating layer may be applied so as to obtain permanent adhesion between the inner tube and the insulating layer, such as by chemical adhesion, e.g. by applying a primer or glue to the surface of the inner tube before applying the insulating layer, or any other suitable pre-treatment.

High-voltage cables need to be outwardly insulated to prevent contact of conductor with other objects or people. The cable therefore suitably comprises a second electrically insulating layer arranged on the outside surface of the hollow conductor, preventing undesired short circuit and other damage. The material of the second electrically insulating layer is suitably a non-conductive polymeric material, and may have a lower dielectric strength than the material of the first electrically insulating layer, such as e.g. 15-30 kV/mm, preferably 20-25 kV/mm, because the requirement for good heat transfer is not so high on the conductor outside, and the second electrically insulating layer may therefore have a higher material thickness than the first electrically insulating layer. For example, the second electrically insulating layer may be made of a polymeric material, such as polyethylene, such as XLPE, which has a considerably lower cost than materials having higher dielectric strength. The second electrically insulating layer is preferably not permanently adhered to the surface of the conductor, in order to allow is to be peeled off for electrical connecting purposes.

A shield layer of metal is suitably arranged outside the second electrically insulating layer to avoid disturbance due to magnetic fields. The shield layer may be a braided layer or, more preferably, a layer obtained in the form of an extruded tube, which can be applied by inserting the insulated connector into an extruded tube intended to form the shield, which is explained in more detail below. A shield layer in the form of an extruded tube increases the strength of the cable, such that the number of fixing points when mounting it, e.g. in a vehicle, can be reduced, and automated mounting can be allowed. An extruded shield layer further gives the cable better bending properties, as compared to a braided shield layer. If desired, a polymer coating may be provided on the surface of the shield. The outer coating on the surface of the shield may be a polyamide. Such a coating can have a specific colour to indicate the type of high-voltage cable.

Various materials could be contemplated for the inner tube, as long as the material allows the tube to be expanded at relatively low temperatures so as to come into contact with inner surface of the hollow conductor and are impermeable to gas and liquids. The inner tube is preferably made of metal due to the excellent heat transfer properties and the non-permeability for gas and liquids in metals. The inner tube and/or the hollow conductor and/or the shield layer may advantageously be made of aluminium or an aluminium alloy, due to the low weight and relatively low cost of aluminium and aluminium alloys, as compared to e.g. copper. Suitable aluminium alloys for the inner metal tube and shield layer may be for example AA3000-series alloys, e.g. AA3003, which have good drawability, and for the hollow conductor an AA6000-series alloy or an AA1000-series alloy may be used, depending on the needs in the specific application. AA6000-series alloys have higher strength and elongation properties compared to AA1000-series alloys, and AA1000-series alloys have higher conductivity compared to AA6000. Thus, for example when there is a need to form a connector portion on the conductor, e.g. by cold forming, an alloy having higher mechanical strength such a AA6000-series alloy may be preferred. In the present disclosure, reference to AA1xxx, AA3xxx-series and AA6xxx-series aluminium alloys refer to the nomenclature of the Aluminum Association which uses a four-digit system for wrought alloy composition families (ref. “International Alloy Designations and Chemical Composition Limits for Wrought Aluminum and Wrought Aluminum Alloys”, by The Aluminum Association, Inc).

At high-voltage, the material in a solid cable tends to get hot unless the diameter is large enough. As mentioned above, the high-voltage cable of the present disclosure can have a smaller cross-sectional area than a solid non-cooled high-voltage cable for a corresponding voltage application, due to the interior cooling. Accordingly, with the construction as defined above, the cable may have a cross-sectional area 70-200 mm². A cross-sectional area of 70-120 mm² would correspond to a solid cable having a cross-sectional area of around 200-250 mm² for the same voltage application. The inner tube may suitably have an outer diameter of 6-12 mm. In some embodiments the outer diameter of the inner tube may be 6-10 mm. In some embodiments the outer diameter of the inner tube may be 8-12 mm. Using gas as a cooling medium will generally involve using an inner pipe with smaller inner diameter and larger wall thickness compared with a liquid cooling medium, which will allow smaller wall thickness and larger diameter of the inner tube. Due to the small diameter and the interior space, the cost and weight can be considerably reduced. It should however be understood that other cross-sectional areas and inner tube dimensions can be realized dependent on the application of the cable.

A typical operating environment temperature may be around 125° C.

The high-voltage cable of the present disclosure may typically not be flexible, due to the preferred choices of extruded metal tubes for use as the inner tube, the conductor and preferably also the outer shield. The cable may therefore need to be bent to its final shape using bending tools.

The present disclosure further relates to a method of manufacture of the cable described above. The method comprises the steps of:
Providing a first extruded metal tube for use as an inner tube in the cable;
Applying a coating layer of an electrically insulating material onto an outer surface of the extruded inner metal tube, to obtain a coated inner tube having a first electrically insulating layer;
Providing a second extruded tube of electrically conducting material to obtain a hollow conductor.
Inserting the coated inner tube into the hollow conductor and expanding it until the first electrically insulating layer is in contact with the inner surface of the hollow conductor.

By first applying the electrically insulating material of the first electrically insulating layer onto the extruded inner tube, and then inserting it into the hollow conductor and thereafter expanding the inner extruded tube together with the electrically insulating layer until it is in contact with the inner surface of the hollow conductor, the first electrically insulating layer can be arranged to be mechanically held between the outer surface of the inner metal tube and the inner surface of the hollow conductor. Thereby, it can be ensured that the first electrically insulating layer is held in position so that no leakage between the inner tube and the connector can arise. This way of applying the first electrically insulating layer also allows the inner metal tube and the first electrically insulating layer to permanently adhere to each other. Chemical adhesion may be used, since an adhesion agent, such as a primer or glue can be applied to the inner metal tube before application of the first electrically insulating layer. Alternatively, any other suitable pre-treatment may be used to obtain the adhesion. Permanent adhesion is advantageous because it further ensures that any leaks are avoided, and that the heat transfer is decreased due to air present between the layers, and it decreases the risk of wrinkles when the cable is bend during installation in the final application. An adhesion agent, such as glue or primer, can also be applied to the interior surface of the hollow conductor before insertion of the inner tube, thereby further improving the adhesion between the components inside the conductor.

The first electrically insulating layer can be applied in various ways, such as by co-extrusion, powder coating etc., as long as the applied layer covers the entire outer surface of the inner tube, without any gaps or cracks, and can be expanded and bent without being damaged. Most preferably, the first electrically insulating layer is applied to the first extruded tube by co-extrusion, which is an efficient way to obtain an even coating of high quality.

The expansion of the coated inner tube inserted into the hollow conductor is suitably a cold forming method, preferably performed by drawing a plug through the interior of the inner tube, where the plug is tapering and has a largest diameter selected such that the inner tube and its coating will be forced against the inner surface of the hollow conductor. Alternatively, the inner tube and its coating can be expanded toward the hollow conductor by hydroforming.

The method may also comprise applying a coating layer of an electrically insulating material onto an outer surface of the hollow conductor, to obtain a coated hollow conductor having a second electrically insulating layer. This step may preferably be performed prior to inserting the inner tube into the hollow connector. The second electrically insulating layer may be applied as discussed above by powder coating, or may be wound of braided about the outer surface of the conductor. Most preferably the second electrically insulating layer is applied by co-extrusion, to obtain an even and fully covering coating.

Furthermore, the method may comprise the step of providing a shield layer in the form of a third extruded metal tube. Optionally, a coating layer can be applied onto an outer surface of the third extruded metal tube, to obtain a third coated tube. The coated hollow conductor can then be inserted into the shield layer tube, and the hollow conductor, coated with its insulation layer, and the optionally coated shield can then be formed into an assembly by reducing the cross-section diameter of the third extruded metal tube, so as to bring the layers in contact with each other.

The forming of the coated hollow conductor and the shield into an assembly by reducing the cross-section diameter of the third extruded metal tube is preferably performed prior to inserting the coated inner tube into the hollow conductor. The reduction of the cross-section diameter of the third extruded metal tube may be performed by swaging, hammering, pressure, roll forming or drawing. Preferably the forming of the coated hollow conductor and the shield into an assembly is done by swaging.

If desired, the method may further comprise bending the cable into a desired shape by means of bending tools

A connection may be formed at an end of the inner metal tube, e.g. by cold forming, so that the inner tube can be connected to a cooling fluid circuit. Depending on the material of the first electrically insulation layer, the coating layer may need to be removed before forming the connection. Polyamide used for the first electrically insulating layer has the advantage that it can be formed along with the inner tube and need not be removed.

In the present disclosure, when extrusion of a tube is referred to, that step may typically include extrusion, drawing and cutting to length. In case of co-extrusion of a coating onto an extruded tube, this may further include the co-extrusion of the coating before cutting to length, followed by any heat treatment, and then cutting to length.

### BRIEF DESCRIPTIONS OF THE DRAWINGS

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

FIG. 1 is a perspective view of a cable according to the present disclosure;

FIG. 2 is a schematic cross-sectional view of the cable in FIG. 1;

FIG. 3 is a schematic cross-sectional view along the line A-A in FIG. 2;

FIG. 4 schematically illustrates the method of manufacturing a cable according to the present disclosure.

### EXAMPLE EMBODIMENTS

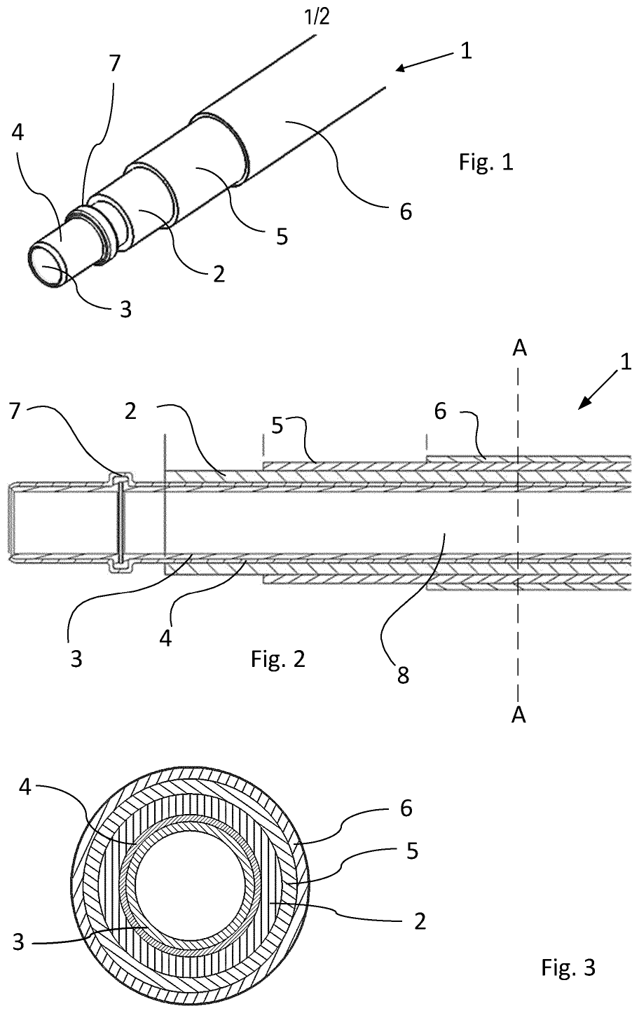

FIGS. 1-3 shows a high-voltage cable 1, comprising a hollow conductor 2, characterized in that an inner metal tube 3 is arranged inside the hollow conductor 2, and a first electrically insulating layer 4 is arranged between the inner metal tube 3 and the hollow conductor 2, wherein the first electrically insulating layer 4 is in direct contact with the entire outer surface of the inner tube 3 and the entire inner surface of the hollow conductor tube 2. In the illustrated example, the cable includes a second electrically insulating layer 5 arranged on the outside surface of the hollow conductor 2 and a shield layer 6 arranged outside the second electrically insulating layer 5. As mentioned above, the shield may be coated with an optional outer layer (not shown).

For illustration purposes, the second electrically insulating layer 5 and the shield are cut away in FIGS. 1-2.

A connector 7 is formed at the end of the inner tube, so that the inner tube can be connected to a cooling fluid circuit (not shown) to allow the cooling fluid to flow though the interior space 8 of in inner tube.

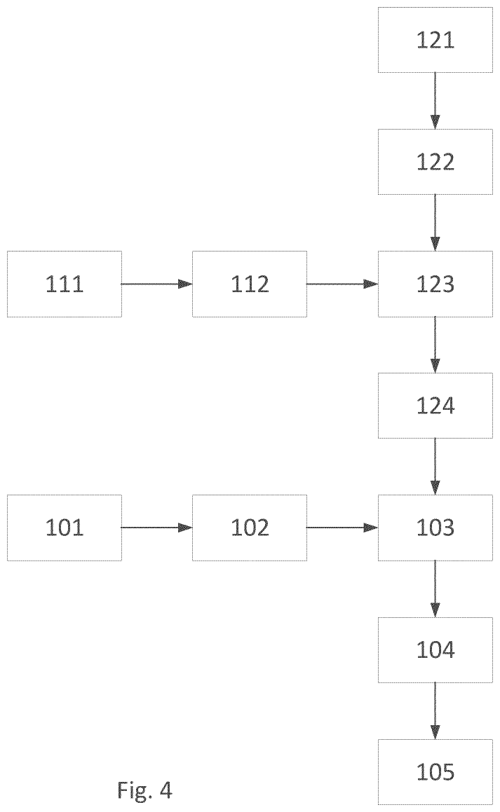

FIG. 4 illustrates a method of manufacture of the cable described above, comprising the steps of providing 101 a first extruded metal tube 3; applying 102 a coating layer of an electrically insulating material onto an outer surface of the extruded metal tube 3, to obtain a coated inner tube having a first electrically insulating layer 4; providing 111 a second extruded tube of electrically conducting material to obtain a hollow conductor 2; and inserting 103 the coated inner tube into the hollow conductor 2 and expanding 104 it until the first electrically insulating layer 4 is in contact with the inner surface of the hollow conductor 2.

As mentioned above, the first electrically insulating layer 4 is preferably applied 102 to the first extruded metal tube 3 by co-extrusion. The expansion 104 of the coated inner tube is suitably a cold forming method, preferably performed by drawing a plug through the inner tube, or by hydroforming.

The method may further comprise applying 112 a coating layer of an electrically insulating material onto an outer surface of the hollow conductor, to obtain a coated hollow conductor 2 having a second electrically insulating layer 5, wherein the second electrically insulating layer is preferably applied by co-extrusion.

The method may also comprise providing 121 a shield layer in the form of a third extruded metal tube; optionally applying 122 a coating layer onto an outer surface of the third extruded tube 3, to obtain a third coated tube; and inserting 123 the coated hollow conductor into the third extruded metal tube; and forming 124 the coated hollow conductor and the shield layer into an assembly by swaging. Suitably, the forming 124 the coated hollow conductor and the shield into an assembly by swaging may be performed prior to inserting 103 the coated inner tube into the hollow conductor 2.

The method may further comprise bending 105 the cable into a desired shape by means of a bending tool.

1. A high-voltage cable (1), comprising a hollow conductor (2), wherein an inner tube (3) made of metal is arranged inside the hollow conductor (2), and a first electrically insulating layer (4) is arranged between the inner tube (3) and the hollow conductor (2), wherein said first electrically insulating layer (4) is in direct contact with the entire outer surface of the inner tube (3) and the entire inner surface of the hollow conductor tube (2).

2. The cable of claim 1, wherein the inner tube (3) is made of aluminium or an aluminium alloy.

3. The cable of claim 1, wherein first electrically insulating layer (4) is made of a material having a dielectric strength of 30 kV/mm or higher.

4. The cable of claim 3, wherein the material of the first electrically insulating layer (4) is a non-conductive polymeric material.

5. The cable of claim 4, wherein the first electrically insulating layer (4) is a polyamide or a polyethylene.

6. The cable of claim 1, further comprising a second electrically insulating layer (5) arranged on the outside surface of the hollow conductor (2).

7. The cable of claim 6, further comprising a shield layer (6) arranged outside the second electrically insulating layer (5), said shield layer preferably being made of aluminium or an aluminium alloy.

8. The cable of claim 7, wherein the shield layer is an extruded tube.

9. The cable of claim 1, wherein the cross-sectional area of the cable is 70-200 mm², such as 70-120 mm².

10. The cable of claim 1, wherein the inner tube (3) has a diameter of 6-12 mm, such as 6-10 mm or 8-12 mm.

11. The cable of claim 1, wherein the cable is suitable for installation in electrical vehicles or hybrid electrical vehicles, electrical vessels, or hybrid electrical vessels.

12. The cable of claim 1, wherein the cable is suitable for installation in charging station infrastructure.

13. A method (100) of manufacture of the cable of claim 1, comprising the steps of
providing (101) a first extruded metal tube (3);
applying (102) a coating layer of an electrically insulating material onto an outer surface of the extruded metal tube (3), to obtain a coated inner tube having a first electrically insulating layer (4);
providing (111) a second extruded tube of electrically conducting material to obtain a hollow conductor (2);
inserting (103) the coated inner tube into the hollow conductor (2) and expanding (104) it until the first electrically insulating layer (4) is in contact with the inner surface of the hollow conductor (2).

14. The method of claim 13, wherein the first electrically insulating layer (4) is applied (102) to the first extruded metal tube (3) by co-extrusion or powder coating.

15. The method of claim 13, wherein the expansion (104) of the coated inner tube is a cold forming method.

16. The method of claim 15, wherein the expansion (104) of the coated inner tube is performed by drawing a plug through the inner tube, or by hydroforming.

17. The method of claim 13, further comprising
applying (112) a coating layer of an electrically insulating material onto an outer surface of the hollow conductor, to obtain a coated hollow conductor (2) having a second electrically insulating layer (5).

18. The method of claim 17, wherein the second electrically insulating layer is applied by co-extrusion.

19. The method of claim 13, further comprising
providing (121) a shield layer in the form of a third extruded metal tube;
optionally applying (122) a coating layer onto an outer surface of the third extruded tube (3), to obtain a third coated tube;
inserting (123) the coated hollow conductor into the third extruded metal tube;
forming (124) the coated hollow conductor and the shield layer into an assembly by reducing the cross-section diameter of the third extruded metal tube.

20. The method of claim 19, wherein the forming (124) the coated hollow conductor and the shield into an assembly by reducing the cross-section diameter of the third extruded metal tube is performed prior to inserting (103) the coated inner metal tube into the hollow conductor (2).

21. The method of claim 19, wherein the forming (124) of the coated hollow conductor and the shield layer into an assembly is done by swaging, hammering, pressuring, roll forming or drawing.

22. The method of claim 19, wherein the forming (124) of the coated hollow conductor and the shield layer into an assembly is done by swaging.

23. The method of claim 13, further comprising bending the cable into a desired shape.
